(19) United States
(12) Patent Application Publication
(10) Pub. No.: US 2026/0043650 A1
(43) Pub. Date: Feb. 12, 2026

(54) METHOD AND SYSTEM FOR ENHANCED BATHYMETRIC ESTIMATION THROUGH INTEGRATED SATELLITE IMAGERY AND ALTIMETER DATA ANALYSIS

(71) Applicants: Muhammad Saeed, Abu Dhabi (AE); Ali Abdulkareem AlHammadi, Abu Dhabi (AE); Yasser Fowad Mohamed Abdulla Alwahedi, Abu Dhabi (AE); Wassim Mohamed Baba, Toulouse (FR); Dmitry Mikhaylov, Dubai (AE)

(72) Inventors: Muhammad Saeed, Abu Dhabi (AE); Ali Abdulkareem AlHammadi, Abu Dhabi (AE); Yasser Fowad Mohamed Abdulla Alwahedi, Abu Dhabi (AE); Wassim Mohamed Baba, Toulouse (FR); Dmitry Mikhaylov, Dubai (AE)

(21) Appl. No.: 18/799,790

(22) Filed: Aug. 9, 2024

(51) Int. Cl. G01C 13/00; G06T 7/11; G06T 7/50

(52) U.S. Cl. CPC G01C 13/008; G06T 7/11; G06T 7/50; G06T 2207/10032; G06T 2207/20081; G06T 2207/20084

(57) ABSTRACT

Method, system, and non-transitory computer readable storage medium are provided for creating a shelf bathymetric map. In some embodiments, a satellite image with a shelf area and related altimeter data for at least a number of points of the shelf area are obtained. The shelf area in the satellite image and depth values for the shelf area from said altimeter data are selected. The selected depth values are associated with points of the shelf area based on geo-coordinates. A training dataset and a testing dataset are created from the associated points. A neural network is trained on the training dataset. The neural network is tested on the testing dataset. Inference of the neural network is adjusted based on testing results. A depth value for each satellite image pixel of the shelf area is predicted by the neural network.

### TECHNICAL FIELD

The present invention relates in general to the field of marine geospatial analysis and remote sensing. More particularly, the present invention relates to estimation of underwater topography or bathymetry using advanced computational methods, satellite imagery, and altimetric data trained by a small amount of observation data.

### BACKGROUND

Satellite-Based Bathymetry (SDB) has undergone transformational advancements, particularly in the application of technological methods such as multispectral remote sensing, InSAR, LiDAR, and SfM to estimate water depth. The emergence of machine learning and deep learning techniques have notably enhanced the accuracy and precision of SDB, especially in regions characterized by intricate seabed terrains [1], [2], [3], [4], [5]. Recent studies, such as those conducted by Tonion et al. [6]and Sonogashira et al. [7], have illustrated the potential of machine learning in this domain, assessing water depth estimation and high-resolution bathymetric chart creation, respectively. Furthermore, research by Najar et al. [8] compared deep learning methods to traditional physics-based methods, emphasizing the significance of modern algorithms in bathymetry estimation. Other innovative approaches have been explored, including the combination of remote sensing data, machine learning, and techniques like the Bathy algorithm to generate accurate bathymetric maps, as demonstrated in studies by Xie et al. [9], Merchant et al. [10], and Lange et al. [11]. Such evolving methodologies, ranging from the application of Sentinel-2 images for bathymetric mapping of the Nile River to the introduction of physics-informed neural networks, underscore the dynamic nature of current SDB research and its potential for future breakthroughs [12], [13].

In recent years, the arena of bathymetry research has been enriched by the integration of satellite data and machine learning techniques to enhance water depth estimation. Surisetty et al. [14] highlighted the prowess of non-linear Support Vector Regression (SVR) in assessing nearshore depths using Sentinel-2 multi-spectral images [14]. Similarly, Zhong et al. (2022) [5] introduced the DL-NB framework, an innovative model employing ICESat-2 LiDAR and Sentinel-2 imagery, promising high-precision bathymetric maps. Moran et al. [15] delved into the realm of genetic algorithms, striving for better bathymetry predictions. At the same time, Liu et al. [16] addressed the global challenge of inconsistent lake bathymetry data by comparing XGBoost to traditional interpolation methods.

Further contributions by Chen et al. [17] leveraged machine learning models to map Arctic coastal lake bathymetry, essential data for Arctic environmental studies. Ashfaq et al. [18] analyzed the efficacy of various regression algorithms for bathymetry in sediment-rich coastal areas. Diving deeper into riverine environments, Ghorbanidehno et al. [19] introduced a deep-learning framework for estimating riverbed topography from flow velocity metrics. Misra et al.'s [20] study underscored the coastal geographic alterations in Puducherry, India, using SDB and SVR for depth estimations. Lastly, the 2019 research by MA et al. [3] spotlighted the potential of mapping shallow water bathymetry by amalgamating ICESat-2 bathymetric points with Sentinel-2 multispectral imagery, emphasizing the possibility of achieving sub-meter accuracy without in-situ measurements. These studies collectively illuminate the expanding horizons of bathymetric research, characterized by the synergy of advanced technologies and traditional methodologies.

Recent advancements in the domain of bathymetry and remote sensing have seen the harmonious integration of sophisticated machine-learning algorithms and satellite imagery. Misra et al. (2018) [21] ventured into shallow water bathymetry, employing the Support Vector Machine (SVM) technique in tandem with multispectral imagery, achieving notable accuracy with error rates between 8.26% and 14.43% across various regions. Huang et al. [22] pivoted towards SAR target classification, introducing a transfer learning approach with SAR scene images and deep CNNs, presenting a promising solution to the challenge of limited labeled data in this domain.

Diving into the vibrant ecosystem of shallow coral reef waters, Manessa et al. [23] showcased the prowess of the Random Forest (RF) algorithm in satellite-derived bathymetry, highlighting its superiority over Multiple Linear Regression (MLR). Their utilization of Worldview-2 satellite imagery in tandem with water depth samples from regions like the Gili Islands and Panggang Island has opened avenues for further research in similar environments. Taking a leap back to 1978, Lyzenga et al. [24] probed into the potential of passive remote sensing for mapping water depths and bottom features. However, this pioneering work left much to be desired in terms of specific details on techniques, accuracy, and data sources.

Collectively, these studies underline the strides made in bathymetric research, encompassing a range of methodologies and applications. Each offers a glimpse into the ever-evolving nexus of satellite imagery, machine learning, and oceanographic studies.

It is clear that there has existed a long and unfilled need in the art for a technique that can provide a scalable, efficient, and economically viable alternative for conducting bathymetric surveys in areas with intricate underwater topographies. The present invention meets this need while avoiding the aforementioned shortcomings of the techniques known in the prior art.

### CITATION LIST

### Non-Patent Literature

[1] M. Ashphaq, P. K. Srivastava, and D. Mitra, “Review of near-shore satellite derived bathymetry: Classification and account of five decades of coastal bathymetry research,” Journal of Ocean Engineering and Science, vol. 6, no. 4, pp. 340-359, 2021, doi:10.1016/j.joes.2021.02.006.

[2] D. R. Lyzenga, “Shallow-water bathymetry using combined lidar and passive multispectral scanner data,” Int J Remote Sens, vol. 6, no. 1, pp. 115-125, 1985, doi:10.1080/01431168508948428.

[3] Y. Ma et al., “Satellite-derived bathymetry using the ICESat-2 lidar and Sentinel-2 imagery datasets,” Remote Sens Environ, vol. 250, no. August, p. 112047, 2020, doi:10.1016/j.rse.2020.112047.

[4] X. Monteys, P. Harris, S. Caloca, and C. Cahalane, “Spatial prediction of coastal bathymetry based on multispectral satellite imagery and multibeam data,” Remote Sens (Basel), vol. 7, no. 10, pp. 13782-13806, 2015, doi:10.3390/rs71013782.

[5] J. Zhong, J. Sun, Z. Lai, and Y. Song, “Nearshore Bathymetry from ICESat-2 LiDAR and Sentinel-2 Imagery Datasets Using Deep Learning Approach,” Remote Sens (Basel), vol. 14, no. 17, 2022, doi: 10.3390/rs14174229.

[6] F. Tonion, F. Pirotti, G. Faina, and D. Paltrinieri, “A machine learning approach to multispectral satellite derived bathymetry,” ISPRS Annals of the Photogrammetry, Remote Sensing and Spatial Information Sciences, vol. 5, no. 3, pp. 565-570, 2020, doi:10.5194/isprs-Annals-V-3-2020-565-2020.

[7] M. Sonogashira, M. Shonai, and M. Iiyama, “High-resolution bathymetry by deep-learning-based image superresolution,” PLoS One, vol. 15, no. 7, pp. 1-19, 2020, doi:10.1371/journal.pone.0235487.

[8] M. Al Najar et al., “Coastal Bathymetry Estimation from Sentinel-2 Satellite Imagery: Comparing Deep Learning and Physics-Based Approaches,” Remote Sens (Basel), vol. 14, no. 5, 2022, doi:10.3390/rs14051196.

[9] C. Xie, P. Chen, Z. Zhang, and D. Pan, “Satellite-derived bathymetry combined with Sentinel-2 and ICESat-2 datasets using machine learning,” Front Earth Sci (Lausanne), vol. 11, no. March, pp. 1-16, 2023, doi:10.3389/feart.2023.1111817.

[10] M. A. Merchant, “ScienceDirect Modelling inland Arctic bathymetry from space using cloud-based machine learning and Sentinel-2,” Advances in Space Research, no. xxxx, 2023, doi:10.1016/j. asr.2023.07.064.

[11] A. Lange, J. Fiedler, M. Merrifield, and R. T. Guza, “UAV Video-Based Estimates of Nearshore Bathymetry,” SSRN Electronic Journal, vol. 185, no. July, p. 104375, 2022, doi:10.2139/ssrn.4174467.

[12] N. Kamal and N. El-Ashmawy, “Potential of Using Machine Learning Regression Techniques to Utilize Sentinel Images for Bathymetry Mapping of Nile River,” The Egyptian Journal of Remote Sensing and Space Science, vol. 26, no. 3, pp. 545-555, 2023, doi:10.1016/j.ejrs.2023.06.004.

[13] Q. Chen, N. Wang, and Z. Chen, “Simultaneous mapping of nearshore bathymetry and waves based on physics-informed deep learning,” Coastal Engineering, vol. 183, no. May, p. 104337, 2023, doi:10.1016/j.coastaleng.2023.104337.

[14] V. V. A. K. Surisetty, C. Venkateswarlu, B. Gireesh, K. V. S. R. Prasad, and R. Sharma, “On improved nearshore bathymetry estimates from satellites using ensemble and machine learning approaches,” Advances in Space Research, vol. 68, no. 8, pp. 3342-3364, 2021, doi:10.1016/j.asr.2021.06.034.

[15] N. Moran, B. Stringer, B. Lin, and M. T. Hoque, “Machine learning model selection for predicting bathymetry,” Deep Sea Res 1 Oceanogr Res Pap, vol. 185, no. May, p. 103788, 2022, doi:10.1016/j. dsr.2022.103788.

[16] K. Liu and C. Song, “Modeling lake bathymetry and water storage from DEM data constrained by limited underwater surveys,” J Hydrol (Amst), vol. 604, no. August 2021, p. 127260, 2022, doi:10.1016/j.jhydrol.2021.127260.

[17] H. Chen, A. P. Yunus, S. Nukapothula, and R. Avtar, “Modelling Arctic coastal plain lake depths using machine learning and Google Earth Engine,” Physics and Chemistry of the Earth, vol. 126, no. March 2021, p. 103138, 2022, doi:10.1016/j.pce.2022.103138.

[18] M. Ashphaq, P. K. Srivastava, and D. Mitra, “Analysis of univariate linear, robust-linear, and non-linear machine learning algorithms for satellite-derived bathymetry in complex coastal terrain,” Reg Stud Mar Sci, vol. 56, p. 102678, 2022, doi:10.1016/j.rsma.2022.102678.

[19] H. Ghorbanidehno, J. Lee, M. Farthing, T. Hesser, E.F. Darve, and P. K. Kitanidis, “Deep learning technique for fast inference of large-scale riverine bathymetry,” Adv Water Resour, vol. 147, no. October 2019, 2021, doi:10.1016/j.advwatres.2020.103715.

[20] A. Misra and B. Ramakrishnan, “Assessment of coastal geomorphological changes using multi-temporal Satellite-Derived Bathymetry,” Cont Shelf Res, vol. 207, no. May, p. 104213, 2020, doi:10.1016/j.csr.2020.104213.

[21] A. Misra, Z. Vojinovic, B. Ramakrishnan, A. Luijendijk, and R. Ranasinghe, “Shallow water bathymetry mapping using Support Vector Machine (SVM) technique and multispectral imagery,” Int J Remote Sens, vol. 39, no. 13, pp. 4431-4450, 2018, doi:10.1080/01431161.2017.1421796.

[22] Z. Huang, Z. Pan, and B. Lei, “Transfer learning with deep convolutional neural network for SAR target classification with limited labeled data,” Remote Sens (Basel), vol. 9, no. 9, pp. 1-21, 2017, doi:10.3390/rs9090907.

[23] M. D. M. Manessa et al., “Satellite-Derived Bathymetry Using Random Forest Algorithm and Worldview-2 Imagery,” Geoplanning: Journal of Geomatics and Planning, vol. 3, no. 2, p. 117, 2016, doi:10.14710/geoplanning.3.2.117-126.

[24] D. R. Lyzenga, “Passive remote sensing techniques for mapping water depth and bottom features,” Appl Opt, vol. 17, no. 3, p. 379, 1978, doi:10.1364/ao.17.000379.

### SUMMARY OF THE INVENTION

The technical problem addressed by the invention involves accurately determining sea floor depth using satellite altimeter data. The invention incorporates advanced processing techniques, including the use of neural networks, to address the problem and provide more accurate sea floor depth information.

This disclosure introduces a sophisticated approach for bathymetric estimation utilizing a fusion of high-resolution satellite imagery and precise altimeter data, analyzed through a customized deep learning framework. The present disclosure excels in the Gulf region by employing advanced neural networks that process and interpret combined data sets to generate detailed and accurate bathymetric maps. The inventiveness of this approach lies in its effective use of the synergistic potential of cutting-edge remote sensing technology and state-of-the-art machine learning algorithms. The incorporation of altimeter data significantly enhances the precision of depth estimations, achieving an RMSE of less than 30 cm. This innovative technique transcends the constraints of conventional echo-sounding methods, presenting a scalable, efficient, and economically viable alternative for conducting bathymetric surveys in areas with intricate underwater topographies.

In first aspect of the disclosure, a computer-implemented method for creating a shelf bathymetric map includes: obtaining a satellite image with a shelf area and related altimeter data for at least a number of points of the shelf area; selecting the shelf area in the satellite image and depth values for the shelf area from said altimeter data; associating the selected depth values with points of the shelf area based on geo-coordinates; creating a training dataset and a testing dataset from the associated points; training a neural network on the training dataset; testing the neural network on the testing dataset; adjusting inference of the neural network based on testing results; and predicting, by the neural network, a depth value for each satellite image pixel of the shelf area.

With reference to the first aspect, in some possible implementations of the first aspect, the method further includes applying tidal correction to the predicted depth values.

With reference to the first aspect, in some possible implementations of the first aspect, the selecting the shelf area in the satellite image further includes creating a binary mask for the shelf area.

With reference to the first aspect, in some possible implementations of the first aspect, the associating the selected depth values with points of the shelf area further includes matching satellite image data and altimeter data in scale, units and coordinates.

With reference to the first aspect, in some possible implementations of the first aspect, the method further includes saving the predicted depth values in combination with the selected depth values as a shelf bathymetric map.

With reference to the first aspect, in some possible implementations of the first aspect, the satellite image is obtained from a satellite image source, and the related altimeter data is obtained from an altimeter data source.

In second aspect of the disclosure, a system for creating a shelf bathymetric map includes a server device, wherein the server device comprises one or more processors, one or more computer readable storage devices, and program instructions stored on at least one of the one or more computer readable storage devices for execution by at least one of the one or more processors cause the at least one of the one or more processors to: obtain a satellite image with a shelf area and related altimeter data for at least a number of points of the shelf area; select the shelf area in the satellite image and depth values for the shelf area from said altimeter data; associate the selected depth values with points of the shelf area based on geo-coordinates; create a training dataset and a testing dataset from the associated points; train a neural network on the training dataset; test the neural network on the testing dataset; adjust inference of the neural network based on testing results; and predict, by the neural network, a depth value for each satellite image pixel of the shelf area.

In third aspect of the disclosure, a non-transitory computer readable storage medium having program instructions stored therein, which when executed by a computer device, cause the computer device to perform the method in accordance with the first aspect and any possible implementations of the first aspect.

These and other capabilities of the disclosed subject matter will be more fully understood after a review of the following figures, detailed description, and claims. It is to be understood that the phraseology and terminology employed herein are for the purpose of description and should not be regarded as limiting.

### BRIEF DESCRIPTION OF DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 is a scatter plot for comparison of observed bathymetry derived from multi-beam sonar data versus predicted bathymetry obtained from the deep learning methodology applied to high-resolution satellite images of the present disclosure in Jbel Dhanna.

FIG. 2 shows side-by-side comparison of bathymetric maps with the estimated bathymetry of the present invention on the left and the measured bathymetry acquired from multi-beam sonar data on the right.

FIG. 3 is an enhanced detail bathymetric map according to the present disclosure.

FIG. 4 is a scatter plot for comparative analysis of bathymetry of the present disclosure with bathymetry measurements obtained from multi-beam sonar data at Khalifa Port.

FIG. 5 is a scatter plot for correlation of observed and modeled bathymetry of the present disclosure at Mirfa region.

### DETAILED DESCRIPTION

The technique of the present invention can be implemented in a variety of software means executable on at least one computing device. In some embodiments, the computing device includes a server device, and the software means include software program modules executable on the server device. In addition to the software program modules, the software means include implementation of neural network.

Various embodiments are further described herein below in the context of the server device automatically implementing operations of a process according to the technique of the present invention.

In general, the process relates to for bathymetric estimation utilizing a fusion of high-resolution satellite imagery and precise altimeter data. In some embodiments, the process relates to a method for creating a shelf bathymetric map.

In some embodiments, such essential libraries as geopandas, rasterio, tensorflow, and others are imported, which facilitate geospatial analysis, data manipulation, and neural network modeling.

The process of the present invention starts with obtaining a satellite image comprising a coastal or shelf region or area. The satellite image can be obtained from a satellite image source or can be downloaded from any remote satellite imagery server or other storage of satellite images. In some preferred embodiments, the satellite images include high-resolution satellite images.

In addition to the satellite image, altimeter data is obtained from an altimeter data source. The altimeter data includes true depth values for at least some points of the coastal or shelf region or area in the satellite image. In some embodiments, true depth values for up to 100 points can be sufficient. This altimeter data related to the satellite image can be obtained an altimeter data source. The altimeter data can be obtained using automated scripts executed on the server device.

The sources of the altimeter data include:
Satellite Altimeters: These instruments orbit Earth and use radar or laser technology to measure the distance from the satellite to the Earth's surface. They are crucial for understanding sea level rise, wave heights, and the topography of the Earth's land and ice surfaces.
Airborne Altimeters: Mounted on aircraft, these altimeters can provide high-resolution data over specific areas, useful for detailed mapping and surveying tasks.
Ground-Based Altimeters: These are used in various applications, including handheld devices for hikers or mounted instruments for geological or surveying purposes.

In some embodiments, the altimeter data can be obtained from such sources as ICESat-2, SWOT, Sentinel-3. For example, ICESat-2 data can be downloaded using automated scripts tailored to the regions of interest in the satellite image and specified date ranges. This involves accessing NASA's Open Altimetry API and other repositories to fetch the ATL03 and ATL08 data products.

Altimeter data in the context of the present invention typically provide information about a distance from the sea floor to the top of a wave. This is the total measurement combining the depth of the sea floor and the height of the waves. However, it can be adiitionally post-processed to extract true depth values (a distance from sea floor to sea level).

The downloaded altimeter data is preprocessed to filter out noise and non-water returns. This includes applying algorithms to distinguish between water and non-water photons based on the ATL08 classification flags and geophysical parameters.

In some embodiments, the altimeter data may further provide tidal measurements. In some other embodiments, tides are estimated at 30-minute intervals globally via API.

In some embodiments, the altimeter data can provide density of points between 10 ot 25 points per squere meter.

Then, the process of the present invention includes selecting the shelf area in the satellite image. In some embodiments, the selecting includes creating a binary mask for the shelf area to segment the satellite image.

Binary masks in satellite imagery segmentation are essential tools in software development for image processing, especially in remote sensing and GIS applications. They are 2D arrays matching the dimensions of the original image, with elements assigned a value of 0 (black) or 1 (white) to denote exclusion or inclusion in the region of interest, respectively. The creation of these masks is managed by identifying specific features in the imagery (such as vegetation, water bodies, or urban areas) and often involves thresholding techniques where pixels are classified based on their intensity values relative to a predefined threshold. This approach facilitates isolation of specific areas for analysis, enabling precise monitoring and evaluation of environmental and urban parameters. The approach encapsulates both the visual simplicity of binary masks and the complex algorithms behind their generation, embodying a critical intersection of software engineering principles and geographic analysis.

Further, depth values for the shelf area are selected from the altimeter data. In some embodiments,

The selected depth values are associated with points of the shelf area based on geo-coordinates. In some embodiments, in order to associate the data a preprocessing may be performed.

The preprocessing includes:

1. Coordinate Transformation:
All altimeter data points are transformed to a common coordinate reference system (CRS) to ensure spatial alignment with the satellite imagery and in-situ measurements.
Geopandas and rasterio libraries are employed to handle these transformations and manage geospatial data efficiently.

2. True Depth Point Extraction:
Depth values from ICESat-2 and other altimeter measurements are extracted and stored as bathymetric reference points.
A filtering mechanism is applied to discard outliers and ensure the integrity of the data points.

In some embodiments, the altimeter data is correlated, associated, or matched with satellite image data through a combination of geographic information systems (GIS) techniques and image processing algorithms. This integration process involves several key steps:
Georeferencing: Both the altimeter data and satellite images are georeferenced to a common coordinate system. This ensures that each set of data can be accurately positioned on the Earth's surface.
Data Fusion: Through GIS software or custom algorithms, altimeter data (which provides precise elevation information) and satellite imagery (which offers visual or spectral information about the surface) are fused. This can involve overlaying elevation data on satellite images or vice versa, enhancing the satellite imagery with elevation contours or 3D visualization capabilities.

In some other embodiments, the preprocessing further includes removing the bias from altimeters, and atmospheric correction for the satellite images. The preprocessing is performed by algorithms and techniques implemented that include:
1. Making Data Homogeneous: Ensuring that all data points are consistent in format and units. This might involve converting all measurements to the same unit or ensuring that all data entries follow a standard format.
2. Normalization: Adjusting the values in the data set to a common scale, usually between 0 and 1, without distorting differences in the ranges of values. This is done to ensure that the data fits within a certain range, which is particularly important for neural network inputs.
3. Handling Missing Data: Filling in or removing missing data points to ensure a complete data set for analysis.
4. Filtering Noise: Removing any irrelevant or spurious data points that could interfere with the analysis.

In some embodiments, the satellite image data and the altimeter data matched in scale, units and coordinates, where coordinates include common coordinates or geo-coordinates.

All operations mentioned above are performed to prepare appropriate data for a neural network in accordance with the present invention.

In some embodiments, the data preparation further or alternatively includes: parsing necessary parameters from a specified file (the parameters include information about a type of the used image and information about altimeter data paths); iterating through each paired set of satellite image and altimeter data in the specified directory, opening and reading the data using rasterio and additional custom functions for the altimeter data, organizing it into a format suitable for model training; and processing the combined satellite and altimeter data using the custom ‘prepare_data_for_model’ function, which is enhanced to align the two data types and split them into training and testing sets.

Thus, the prepared or combined data includes the associated points-the points from the shelf area in the satellite image and corresponding true depth values from the altimeter data.

A training dataset and a testing dataset are created from the associated points for the neural network according to the present invention. Herein, a neural network, a neural network model or a model are the terms which can be used interchangeably.
Training Dataset: The model is initially trained on a training dataset. This dataset likely consists of pairs of satellite images and corresponding ground truth depth values. During training, the model learns to predict depth values based on the features present in the satellite images.
Testing Dataset: Once the model is trained, it is evaluated on a separate testing dataset. This dataset contains satellite images for which the ground truth depth values are known but were not seen by the model during training. The model's performance is assessed by comparing its predicted depth values on this unseen data to the known ground truth values. In one embodiment, the training dataset represents 5% and the testing dataset represents 95% of the prepared data.

Then, a new Sequential model is constructed with an added input layer to accommodate altimeter data, or a pre-trained model is loaded from the specified path or directory.

The neural network of the present invention is trained on the training dataset. In one embodiment, the training is performed using the Adamax optimizer and mean squared error loss, over 300 epochs and a batch size of 100, with the ‘CustomPrintCallback( )’ function potentially logging the inclusion of altimeter data during training.

The neural network is tested on the testing dataset. The testing process involves predicting depth values and then evaluating the model's performance on both training and testing datasets. In some embodiments, when evaluating, altimeter data of different dimensions can be added. During sensitivity analysis, different combinations of dimensions can be tested to assess their impact on prediction accuracy and performance. This iterative process helps identify the most suitable dimensionality for reshaping predictions and integrating multiple datasets effectively.

In some embodiments, the evaluation process further includes depth prediction on new combined data using the model. This process further involves reshaping (cubic interpolation) predictions to match the original dimensions, and applying a median filter for noise reduction. The dimensions referred to in the context are likely the spatial dimensions of the satellite imagery. These dimensions represent the width, height, and possibly depth (number of channels) of the satellite image data. They essentially define the grid structure of the image, where each pixel corresponds to a specific location on the Earth's surface.

In the evaluation process, the term “new combined datasets” likely refers to additional data sources beyond the satellite imagery. Specifically, these datasets consist of point-based measurements from altimeters such as ICEsat-2 and SWOT, rather than images. Altimeter data provides valuable information about elevation or height at specific points on the Earth's surface.

In this context, these datasets augment the evaluation process by offering complementary information to the satellite imagery. By incorporating altimeter data alongside the satellite images, the model's predictions can be refined and enhanced. This integration allows for a more comprehensive assessment of the model's performance, leveraging both the spatial detail of the satellite imagery and the precise point-based measurements provided by the altimeter datasets.

Inference or performance of the neural network is adjusted based on at least one of the following: testing results or evaluation results. The adjusted inference ensures model repeatability and flexibility.

Repeatability in the context of AI models refers to the ability of the model to produce consistent results under the same conditions. This includes running the model with the same input data, under the same configuration, and in the same environment. High repeatability is crucial for trust in AI systems, especially in critical applications like healthcare, finance, and autonomous driving. It ensures that outcomes are predictable and reliable over time.

Flexibility in AI models refers to the model's ability to adapt to changes in input data patterns, objectives, or operational environments without requiring significant redesign or retraining. It's about how well the model can handle new, unseen data or tasks. Flexibility is key for AI models to remain effective as they encounter real-world variability and change over time. It enables models to maintain performance in the face of evolving data landscapes, changes in user behavior, or shifts in strategic objectives.

The adjusted neural network predicts a depth value for each satellite image pixel of the shelf area. The depth values are predicted for each pixel in the satellite image. Therefore, the granularity of the depth prediction corresponds to the resolution of the satellite image, meaning it's predicted at the same granularity as the individual pixels in the image. So, for every pixel in the satellite image, there is a corresponding predicted depth value.

In some embodiments, tidal correction is applied to the predicted depth values. If tidal measurements are available they are directly used to correct the values. If they are not available, tidal estimation are used to do the correction. In one embodiment, tides are estimated at 30-minute intervals globally via API. This enables applying tide effects to the estimated bathymetry at the time of the satellite or altimeter passage. In some other embodiments, the tidal correction is performed with the optimal adjustment determined by computing the root mean square error (RMSE) for each correction.

The predicted depth values are saved in combination with the selected depth values as a shelf bathymetric map. In one embodiment, the shelf bathymetric map is saved as a new GeoTIFF file.

The trained and adjusted model is also saved for future use.

This process described above embodies a comprehensive workflow for training a deep learning model on combined geospatial and altimeter data to estimate bathymetry. It ensures efficient processing, accurate model training, and the generation of meaningful, filtered bathymetry predictions saved for subsequent analysis or visualization.

By integrating altimeter data, the neural network is trained on a richer dataset that includes not only the visual cues from the satellite imagery but also the precise surface height measurements, leading to potentially more accurate bathymetric maps

### Enhanced Neural Network Architecture for Bathymetry Estimation

The enhanced neural network in the script according to the present invenion is a feedforward architecture designed to integrate satellite imagery and altimeter data for accurate bathymetry estimation. This architecture effectively processes and merges geospatial data from satellite images with precise altimeter measurements to predict bathymetry values accurately.

### Input Layer

Structure: The network begins with an expanded input layer to accommodate the additional altimeter data. It features 1028 neurons dedicated to the satellite imagery and an appropriate number of neurons for the altimeter data inputs, which may vary based on the specific altimeter data being used.

### Hidden Layers

Configuration: The network consists of several hidden layers with the following configuration of neurons: [512, 512, 256, 256, 128, 128, 64, 64, 32, 32].
Processing: These layers are designed to process and extract features from both types of data efficiently, ensuring the network can learn complex patterns and relationships in the input data.

### Normalization, Activation, and Dropout

Batch Normalization: Implemented in each hidden layer to stabilize learning and improve the training process.
ReLU Activation: Applied to introduce non-linearity, allowing the network to model more complex functions.
Dropout: Set at a 30% rate to prevent overfitting and promote generalization across the network, ensuring the model performs well on unseen data.

### Output Layer

Structure: The final layer of the network has 1 neuron with a linear activation function.
Purpose: This neuron outputs the estimated bathymetry values, providing a continuous prediction of the underwater terrain.

### Compilation

Optimizer: The model is compiled with the ‘adamax’ optimizer, known for its robustness with sparse gradients and effective handling of large datasets.
Loss Function: Mean squared error (MSE) is used as the loss function, quantifying the accuracy of bathymetry predictions by measuring the average squared difference between observed and predicted values.
   Integration with Altimeter Data
Data Sources: The neural network integrates altimeter data from sources such as ICESat-2 and/or SWOT (Surface Water and Ocean Topography). These altimeters provide precise measurements of sea surface height, which are crucial for refining bathymetry estimates.

Enhanced Precision: The inclusion of altimeter data allows the network to better understand the nuances of both satellite imagery and sea surface height data, leading to more accurate bathymetric modeling.

In conclusion, this neural network architecture represents a robust deep learning framework that effectively processes and merges geospatial data from satellite images with precise altimeter measurements. It is trained to predict bathymetry values accurately and is further refined with tidal adjustments for enhanced precision in the final bathymetry estimation.

This revised architecture takes into account the additional data provided by the altimeter, allowing the neural network to better understand the nuances of both satellite imagery and sea surface height data for more accurate bathymetric modeling.

Adding altimeter data to a bathymetry model can enhance it by providing more accurate and high-resolution measurements of sea surface heights. This data helps to correct and refine the model, improving the detection of underwater features and topography. Additionally, altimeter data can fill in gaps where direct bathymetric measurements are sparse, leading to a more comprehensive and detailed representation of the ocean floor.

Unlike sonar, which requires expensive equipment and vessels, altimeter data is significantly more cost-effective and collected via satellites, reducing costs. Moreover, satellite altimeters can cover any region of the world, providing extensive and continuous global measurements. Despite potential post-processing needs, the overall expense and logistical efforts are in general lower compared to traditional observational techniques.

The present invention is preferably accomplished by the embodiments described below, but is not limited thereto.

### Embodiment 1

A computer-implemented method for creating a shelf bathymetric map includes: obtaining a satellite image with a shelf area and related altimeter data for at least a number of points of the shelf area; selecting the shelf area in the satellite image and depth values for the shelf area from said altimeter data; associating the selected depth values with points of the shelf area based on geo-coordinates; creating a training dataset and a testing dataset from the associated points; training a neural network on the training dataset; testing the neural network on the testing dataset; adjusting inference of the neural network based on testing results; and predicting, by the neural network, a depth value for each satellite image pixel of the shelf area.

The method further includes applying tidal correction to the predicted depth values.

The selecting the shelf area in the satellite image further includes creating a binary mask for the shelf area.

The associating the selected depth values with points of the shelf area further includes matching satellite image data and altimeter data in scale, units and coordinates.

The method further includes saving the predicted depth values in combination with the selected depth values as a shelf bathymetric map.

The satellite image is obtained from a satellite image source, and the related altimeter data is obtained from an altimeter data source.

### Embodiment 2

A system for creating a shelf bathymetric map includes a server device, wherein the server device comprises one or more processors, one or more computer readable storage devices, and program instructions stored on at least one of the one or more computer readable storage devices for execution by at least one of the one or more processors cause the at least one of the one or more processors to: obtain a satellite image with a shelf area and related altimeter data for at least a number of points of the shelf area; select the shelf area in the satellite image and depth values for the shelf area from said altimeter data; associate the selected depth values with points of the shelf area based on geo-coordinates; create a training dataset and a testing dataset from the associated points; train a neural network on the training dataset; test the neural network on the testing dataset; adjust inference of the neural network based on testing results; and predict, by the neural network, a depth value for each satellite image pixel of the shelf area.

### Embodiment 3

A non-transitory computer readable storage medium having program instructions stored therein, which when executed by a computer device, cause the computer device to perform the method in accordance with the Embodiment 1.

### Embodiment 4

A system for estimating bathymetry, comprising: a data collection module configured to obtain satellite imagery and altimeter data; a preprocessing module configured to preprocess the obtained data; a neural network configured to receive the preprocessed data and to predict bathymetric values, wherein the neural network includes an input layer, a plurality of hidden layers, and an output layer; and a training module configured to train the neural network using the preprocessed data.

The system according to Embodiment 4 can be implemented as software program modules executable on a computing device. The computing device may include a server device.

The techniques disclosed herein leverage a deep learning approach to process and analyze high-resolution satellite images and altimeter data for bathymetry estimation. By integrating altimeter data with satellite imagery, researchers and decision-makers can gain a more comprehensive understanding of environmental processes and changes.

### EXAMPLES

### Jbel Dhanna Region

To evaluate the performance of the deep learning bathymetry estimation model in the Jbel Dhanna region, specifically focusing on its efficacy in shallow water zones. The variation of bathymetry there is from 0 m to 12 m.
1. Performance Metrics: Despite the inherent challenges associated with shallow waters, the model demonstrated exemplary performance in the Jbel Dhanna region. It was able to accurately capture all depth variations, yielding a Root Mean Square Error (RMSE) of less than 15 cm.
2. Training Data: Intriguingly, in certain images, only 20% of observational data was utilized for training purposes. This implies that a substantial portion of the data was reserved for validation, yet the model's predictions remained precise.

### Conclusion for Test

The Jbel Dhanna use test has conclusively demonstrated the model's robustness and adaptability, especially in challenging shallow water scenarios. Its potential to streamline future observational campaigns, by minimizing the need for extensive data collection without compromising on accuracy, sets a promising precedent for its broader applications in marine science and navigation.

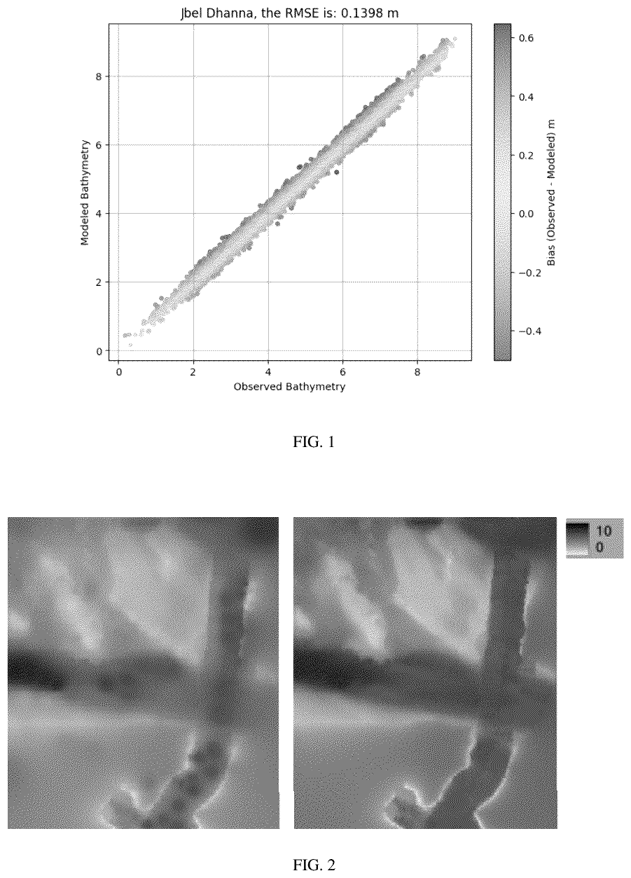

FIG. 1 is scatter plot comparison of observed bathymetry derived from multi-beam sonar data (x-axis, m) versus predicted bathymetry obtained from the deep learning methodology of the present invention applied to high-resolution satellite images (y-axis, m). The model exhibits high accuracy with a low RMSE of 0.1398 meters. The color gradient indicates the bias between observed and predicted values, showcasing the effectiveness of the deep learning approach of the present invention in estimating underwater depth across various locations at Jbel Dhanna.

FIG. 2 is side-by-side comparison of bathymetric maps: the left panel shows the estimated bathymetry using the advanced deep learning approach of the present invention on high-resolution satellite imagery, while the right panel depicts the measured bathymetry acquired from multi-beam sonar data, where the bathymetry is measured for each pixel in the right panel. The similarities in the color patterns across both maps highlight the effectiveness and accuracy of the estimation methodology of the present invention in capturing the underwater terrain (0-10 meters)

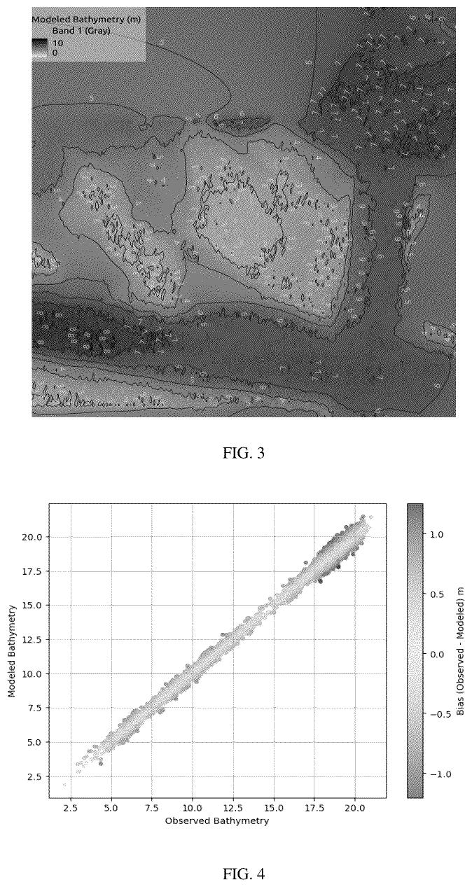

FIG. 3 is an enhanced detail bathymetric map that allows to see the underwater landscape with intricate details. It shows the modeled bathymetry in comparison with multi-beam sonar data. In FIG. 3, the multi-beam sonar data are presented with a combination of colors and numeric values, where the colors indicate depth variations, and numeric values provide precise depth measurements at specific locations. The map uses different shades of blue to indicate depth, with darker shades representing deeper regions and lighter shades for shallower areas. The detailed representation of the sea floor's topology in this map demonstrates the precision of the deep learning methodology of the present invention applied to high-resolution satellite imagery.

### Khalifa and Mirfa Regions Region

Building upon the success of the Jbel Dhanna use test, similar evaluations were conducted in other regions such as Khalifa Port and Mirfa. Remarkably, the results consistently yielded measurements of under 30 cm. This validation across diverse geographical settings reaffirms the model's good performance and reliability, showcasing its capacity to deliver accurate assessments across various marine environments. Such promising outcomes reinforce its potential to revolutionize data acquisition methodologies in marine science and navigation, ensuring precise insights while minimizing the need for extensive data collection.

FIG. 4 is comparative analysis of bathymetry at Khalifa Port. The shown scatter plot illustrates the correlation between bathymetry measurements obtained from multi-beam sonar data and the predictions made by the deep learning model of the present invention using high-resolution satellite imagery. The RMSE of 0.3001 meters signifies the model's precision, with the color gradient representing the bias between the two datasets, demonstrating the model's robustness in estimating underwater depths.

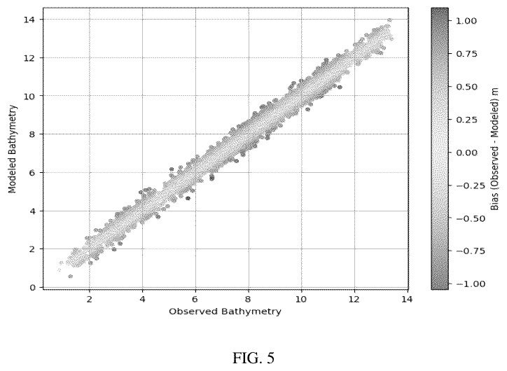

FIG. 5 is correlation of observed and modeled bathymetry at Mirfa region. This scatter plot demonstrates the close alignment between bathymetry data captured by multi-beam sonar and estimations made through the deep learning model of the present invention using satellite imagery (RSME=0.29m). The color-coding of data points highlights the bias between measurements, affirming the model's accuracy in rendering the underwater landscape.

### Advantages and Benefits

1. Enhanced Efficiency in Data Collection: This method emphasizes the enhanced model's capacity to generate precise bathymetric predictions using a smaller (to the number of observational data) subset of observational data, now enriched with altimeter measurements. The observational data in this context refer to the data collected directly from observations or measurements in the field, particularly using SONAR technology. These are different from altimeter data, which are typically obtained from satellite or aerial measurements of the Earth's surface. This synergy is particularly promising for future maritime observational campaigns, indicating a potential reduction in the volume of required direct observations.

2. Increased Operational Value: With the integration of altimeter data, methodology becomes a more powerful tool for shipboard observation campaigns. Marine researchers and navigators can capitalize on the improved model to minimize the need for manual depth measurements. These sporadic yet crucial measurements, when combined with continuous altimeter data, enable the methodology of the present invention to produce extensive and highly accurate bathymetric maps while lessening the need for intensive fieldwork.

3. Cost and Time Efficiency: Leveraging altimeter data alongside traditional observations, the model's capability to perform with limited yet robust training data can lead to significant savings. The integration not only conserves time and resources but also reduces the financial burden typically linked with wide-ranging maritime observational campaigns. The dual-data approach streamlines the bathymetric mapping process, delivering valuable insights more rapidly and economically.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In one or more embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects are described herein with reference to actions or operations according to one or more embodiments. It will be understood that each such operation can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the embodiments of the present disclosure.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the embodiments of the present disclosure.

The functions/actions or operations possible implementations of systems, methods, and computer program products according to various embodiments may represent a module, segment, or portion of instructions, which comprises one or more executable instructions for implementing the specified logical function(s).

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A computer-implemented method for creating a shelf bathymetric map, the method comprising:
obtaining a satellite image with a shelf area and related altimeter data for at least a number of points of the shelf area;
selecting the shelf area in the satellite image and depth values for the shelf area from said altimeter data;
associating the selected depth values with points of the shelf area based on geo-coordinates;
creating a training dataset and a testing dataset from the associated points;
training a neural network on the training dataset;
testing the neural network on the testing dataset;
adjusting inference of the neural network based on testing results; and
predicting, by the neural network, a depth value for each satellite image pixel of the shelf area.

2. The method according to claim 1, further comprising:
applying tidal correction to the predicted depth values.

3. The method according to claim 1, wherein the selecting the shelf area in the satellite image further comprises creating a binary mask for the shelf area.

4. The method according to claim 1, wherein the associating the selected depth values with points of the shelf area further comprises matching satellite image data and altimeter data in scale, units and coordinates.

5. The method according to claim 1, further comprising:
saving the predicted depth values in combination with the selected depth values as a shelf bathymetric map.

6. The method according to claim 1, wherein the satellite image is obtained from a satellite image source, and the related altimeter data is obtained from an altimeter data source.

7. A system for creating a shelf bathymetric map, comprising: a server device, wherein the server device comprises one or more processors, one or more computer readable storage devices, and program instructions stored on at least one of the one or more computer readable storage devices for execution by at least one of the one or more processors cause the at least one of the one or more processors to:
obtain a satellite image with a shelf area and related altimeter data for at least a number of points of the shelf area;
select the shelf area in the satellite image and depth values for the shelf area from said altimeter data;
associate the selected depth values with points of the shelf area based on geo-coordinates;
create a training dataset and a testing dataset from the associated points;
train a neural network on the training dataset;
test the neural network on the testing dataset;
adjust inference of the neural network based on testing results; and
predict, by the neural network, a depth value for each satellite image pixel of the shelf area.

8. A non-transitory computer readable storage medium having program instructions stored therein, which when executed by a computer device, cause the computer device to perform the method of claims 1 to 6.
